(19) United States
(12) Patent Application Publication
(10) Pub. No.: US 2025/0052588 A1
(43) Pub. Date: Feb. 13, 2025

(54) SYSTEM AND METHOD FOR ADAPTIVELY PROVIDING AN ESTIMATED TIME OF ARRIVAL BY PROVIDING A PERSONALIZED MAP OF A DRIVER FOR THE RIDE

(71) Applicant: GRABTAXI HOLDINGS PTE. LTD., Singapore (SG)

(72) Inventors: Philipp Wolfgang Josef KANDAL, Singapore (SG); Ioana Roxana CRISAN, Cluj Napoca (RO); Guanfeng WANG, Singapore (SG); Chen LIANG, Singapore (SG)

(21) Appl. No.: 18/723,637

(22) PCT Filed: Dec. 14, 2022
(86) PCT No.: PCT/SG2022/050905

§ 371 Date: Jun. 24, 2024

(30) Foreign Application Priority Data
Dec. 24, 2021 (SG) 10202114369Q

(51) Int. Cl. G01C 21/34

(52) U.S. Cl. CPC G01C 21/3484

(57) ABSTRACT

A computer-implemented method of adaptively providing an estimated time of arrival and predicting a route likely to be taken by a ride for a ride by providing a personalized map for a driver for the ride. The method comprises: retrieving a recommended route for the ride: identifying historical ride information relating to the driver, the historical ride information identifying a driving behaviour of the driver based on rides that have been taken; and providing a personalized map for the driver based on the retrieved recommended route and the identified historical ride information so as adaptively provide an estimate time of arrival for a ride.

### TECHNICAL FIELD

The present invention relates generally to technology and, in particular, a system and method for providing an estimated time of arrival by providing a personalized map of a driver for the ride.

### BACKGROUND

In Western markets for example, in the US or Europe where most of the navigation or routing technologies is developed, a core assumption for most routing or estimated time arrival (ETA) algorithms is that people mostly follow the significant traffic rules like a road segment attribute (such as turn restrictions, one-way signs). As such, routing algorithms calculate the most accurate route following legal traffic restrictions and then estimate the correct travel time for this route.

In Southeast Asia and other emerging markets this may not be a valid assumption. For example, there are instances when there are drivers who are inclined to take shortcuts that may not always satisfy traffic regulations. Currently, the ETA models implicitly adjust for that but do not really have visibility into specific shortcuts that people are likely to take. As such it is not as accurate as it would be if we would know exactly which shortcuts people take (and possibly personalized as different drivers are more or less likely to take shortcut routes).

However, none of the conventional technique is able to adaptively predict ETA or predict the route that drivers would follow in reality. A need therefore exists to provide a system and method to address the above-mentioned problems.

### SUMMARY

According to a first aspect of the present disclosure, there is a computer-implemented method for adaptively providing an estimated time of arrival for a ride by providing a personalized map for a driver for the ride, the method comprising:
retrieving a recommended route for the ride;
identifying historical ride information relating to the ride, the historical ride information identifying driving behaviour of drivers who have taken the rides before; and
providing a personalized map for the driver based on the retrieved recommended route and the identified historical ride information so as adaptively provide an estimate time of arrival for a ride.

According to a second aspect, there is a server for adaptively providing an estimated time of arrival for a ride by providing a personalized map for a driver for the ride, the server comprising: at least one processor; and at least one memory including computer program code; the at least one memory and the computer program code configured to, with the at least one processor, cause the server at least to:
retrieve a recommended route for the ride;
identify historical ride information relating to the driver, the historical ride information identifying a driving behaviour of the driver based on rides that have been taken; and
provide a personalized map for the driver based on the retrieved recommended route and the identified historical ride information so as adaptively provide an estimate time of arrival for a ride

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1 is a block diagram of a system for adaptively providing an estimated time of arrival for a ride in accordance with an aspect of the present disclosure.

FIG. 2 is a flow chart diagram of a method for adaptively providing an estimated time of arrival for a ride by the graph generating server in the system of FIG. 1.

FIG. 3 is a flow chart diagram of a method for adaptively providing an estimated time of arrival for a ride by the graph generating server in the system of FIG. 1.

FIG. 4 is a flow chart diagram of a method for adaptively providing an estimated time of arrival for a ride by the graph generating server in the system of FIG. 1.

FIGS. 5 and 6 form a schematic block diagram of a computer system upon which a graph generating server in the system of FIG. 1 can be practiced.

FIG. 7 shows an example of a computing device to realize the graph generating server shown in FIG. 1.

### DETAILED DESCRIPTION

### Terms Description

The graph generating server is usually managed by a provider that may be an entity (e.g. a company or organization) which operates to process requests, manage data and provide/display graphical representations that are related to a road network or a plurality of road segments and detections. The graph generating server centralizes the detections from the images collected in each area, and for all users and uses the input to generate the graph. The server may include one or more computing devices that are used for processing data and providing customisable services depending on situations. The graph generating server is also one that is configured to adaptively predict an estimated time of arrival (ETA) for a ride. In some embodiment, the graph generating server is one that is configured to separate real and legal routes for higher accuracy ETA.

The graph generating server manages graph generating information of users and the interactions between users and other external servers, along with the data that is exchanged.

### Example Implementations

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of devices which form public knowledge through their use. Such should not be interpreted as a representation by the present inventor(s) or the patent applicant that such devices in any way form part of the common general knowledge in the art.

The system 100

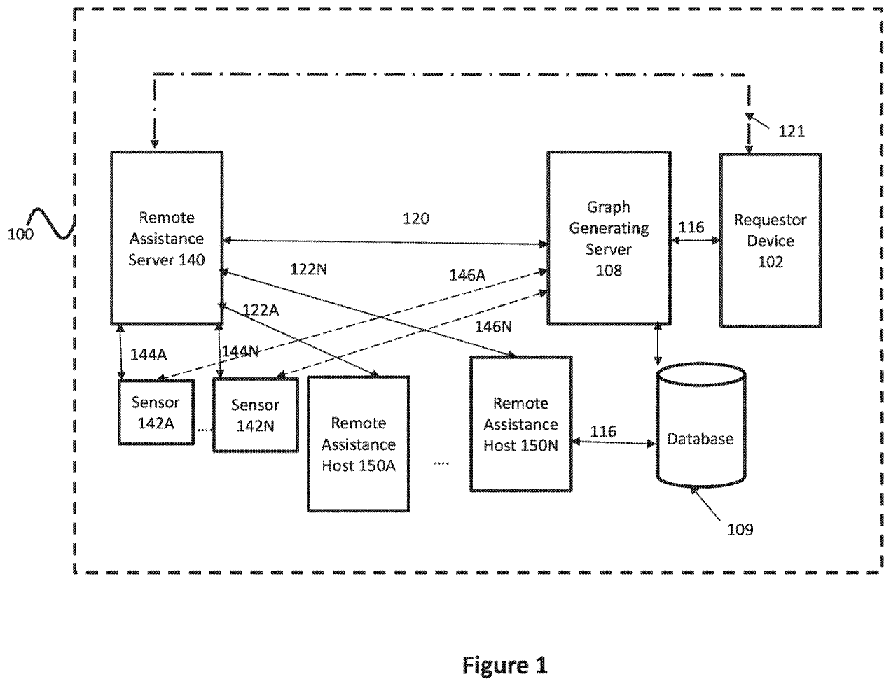

FIG. 1 illustrates a block diagram of a system 100 for providing an ETA of a ride with a higher accuracy. The system 100 comprises a requestor device 102, a graph generating server 108, a remote assistance server 140, remote assistance hosts 150A to 150N, and sensors 142A to 142N. In various embodiments, the disclosure can be applied for graph generating at a server when a road attribute is detected after detecting detections from a plurality of image data form multiple anonymized users.

The requestor device 102 is in communication with a graph generating server 108 and/or a remote assistance server 140 via a connection 116 and 121, respectively. The connection 116 and 121 may be wireless (e.g., via NFC communication, Bluetooth, etc.) or over a network (e.g., the Internet). The connection 116 and 121 may also be that of a network (e.g., the Internet).

The graph generating server 108 is further in communication with the remote assistance server 140 via a connection 120. The connection 120 may be over a network (e.g., a local area network, a wide area network, the Internet, etc.). In one arrangement, the graph generating server 108 and the remote assistance server 140 are combined and the connection 120 may be an interconnected bus.

The remote assistance server 140, in turn, is in communication with the remote assistance hosts 150A to 150N via respective connections 122A to 122N. The connections 122A to 122N may be a network (e.g., the Internet).

The remote assistance hosts 150A to 150N are servers. The term host is used herein to differentiate between the remote assistance hosts 150A to 150N and the remote assistance server 140. The remote assistance hosts 150A to 150N are collectively referred to herein as the remote assistance hosts 150, while the remote assistance host 150 refers to one of the remote assistance hosts 150. The remote assistance hosts 150 may be combined with the remote assistance server 140.

In an example, the remote assistance host 150 may be one managed by an entity and the remote assistance server 140 is a central server that provides graphs at an organization level and decides which of the remote assistance hosts 150 to forward data or retrieve data like image inputs or driver's records.

Sensors 142A to 142N are connected to the remote assistance server 140 or the graph generating server 108 via respective connections 144A to 144N or 144A to 144N. The sensors 142A to 142N are collectively referred to herein as the sensors 146A to 146N. The connections 144A to 144N are collectively referred to herein as the connections 144, while the connection 144 refers to one of the connections 144. Similarly, the connections 146A to 146N are collectively referred to herein as the connections 146, while the connection 146 refers to one of the connections 146. The connections 144 and 146 may be wireless (e.g., via NFC communication, Bluetooth, etc.) or over a network (e.g., the Internet). The sensor 146 may be one of an image capturing device, video capturing device, and motion sensor and may be configured to send an input depending its type, to at least one of the graph generating server 108. The sensors 146 captures inputs including images of a road segment or a road segment attribute and sends the captured inputs to the server 108 which will then provide a graph. The sensors also take in images of a driver on a ride which will then be used to provide a driving behaviour of the driver.

In the illustrative embodiment, each of the devices 102 and 142; and the servers 108, 140, and 150 provides an interface to enable communication with other connected devices 102 and 142 and/or servers 108, 140, and 150. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof.

Use of the term ‘server’ herein can mean a single computing device or a plurality of interconnected computing devices which operate together to perform a particular function. That is, the server may be contained within a single hardware unit or be distributed among several or many different hardware units.

The remote assistance server 140

The remote assistance server 140 is associated with an entity (e.g. a company or organization or moderator of the service). In one arrangement, the remote assistance server 140 is owned and operated by the entity operating the server 108. In such an arrangement, the remote assistance server 140 may be implemented as a part (e.g., a computer program module, a computing device, etc.) of server 108.

The requestor device 102

The requestor device 102 is associated with a subject (or requestor) who is a party to a request that starts at the requestor device 102. The requestor may be a concerned member of the public who is assisting to get data necessary to obtain a graphical representation of a network graph or to obtain a more accurate ETA. The requestor may be a driver or a passenger of the driver or a party expecting the driver to deliver or pick up an item. The requestor device 102 may be a computing device such as a desktop computer, an interactive voice response (IVR) system, a smartphone, a laptop computer, a personal digital assistant computer (PDA), a mobile computer, a tablet computer, and the like.

In one example arrangement, the requestor device 102 is a computing device in a watch or similar wearable and is fitted with a wireless communications interface.

The graph generating server 108

The graph generating server 108 is as described above in the description section.

The graph generating server 108 is configured to adaptively provide an estimated time of arrival for a ride by providing a personalized map for a driver for the ride. The method includes retrieving a recommended route for the ride; identifying historical ride information relating to the ride, the historical ride information identifying a driving behaviour of drivers who have taken the rides before; and providing a personalized map for the driver based on the retrieved recommended road and the identified historical ride information so as adaptively provide an estimate time of arrival for a ride and predict a route likely to be taken by the driver.

The remote access hosts 150

The remote access host 150 is a server associated with an entity (e.g. a company or organization) which manages (e.g. establishes, administers) information regarding information relating to a subject or a member of an organisation. In one embodiment, the server stores information relating to images relating to road segments.

In one arrangement, the entity is an organisation. Therefore, each entity operates a remote access host 150 to manage the resources by that entity. In one arrangement, a remote access host 150 receives a request that a graph for a remote network is requested. The remote access host 150 may then arrange to send resources to graph generating server in response to the plurality of road networks identified in the request. For example, the host may be one that is configured to obtain relevant video or image input for processing.

Advantageously, such information is valuable to predict a road segment attribute e.g. turn restrictions, speed limits based on a graph indicative of a relationship between a road segment and a detection.

This disclosure uses machine learning techniques for detection and geo-localisation. Additionally, the detection's map-matching is also done using machine learning techniques, for example, applying Graph Neural Networks (GNN) for expressing the relationship between the road segments and detections. In an example, not only the individual or just one type of detected traffic signs but all the detected traffic signs from a given area is utilised, regardless of the type that they are.

An extended set of detection's features is used to further augment the available input information (e.g. detections confidence, aspect ratio, distance from camera, etc).

In an embodiment, input data like the road classes and the spatial information about the road network is also used in providing the graph. Such data may be encoded as a graph.

The input data like road classes, spatial information about the road network is encoded or embedded, transformed and aggregated. GNN may be used for this purpose. This may be trained in a supervised manner, in which each node (road segment for one direction) is classified. The output classes are selected based on relevancy for the purpose of mapping a road segment attribute (e.g one way, give way, speed limit, etc).

### Sensor 142

The sensor 142 is associated with a user associated with the requestor device 102. More details of how the sensor may be utilised will be provided below.

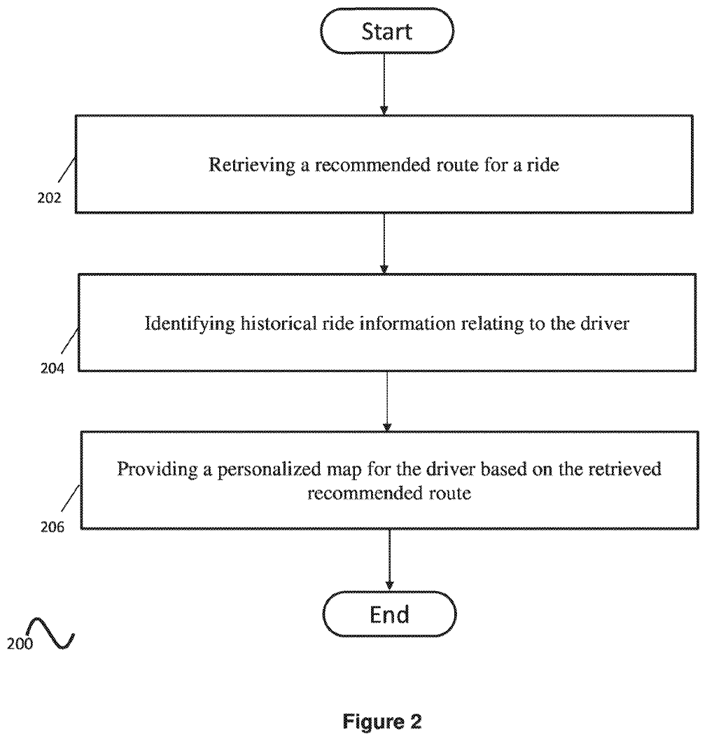

FIG. 2 is a flow chart diagram of a method for adaptively providing an estimated time of arrival for a ride by providing a personalized map for a driver for the ride by the graph generating server in the system of FIG. 1. The method shown in FIG. 2 begins with step 202 by retrieving a recommended route for the ride. Step 204 follows step 202 in which the method includes identifying historical ride information relating to the ride, the historical ride information identifying driving behaviour of drivers who have taken the rides before. Step 206 follows step 204 in which the method adaptively providing a personalized map for the driver based on the retrieved recommended route for the ride and the identified historical ride information so as adaptively provide an estimate time of arrival for a ride.

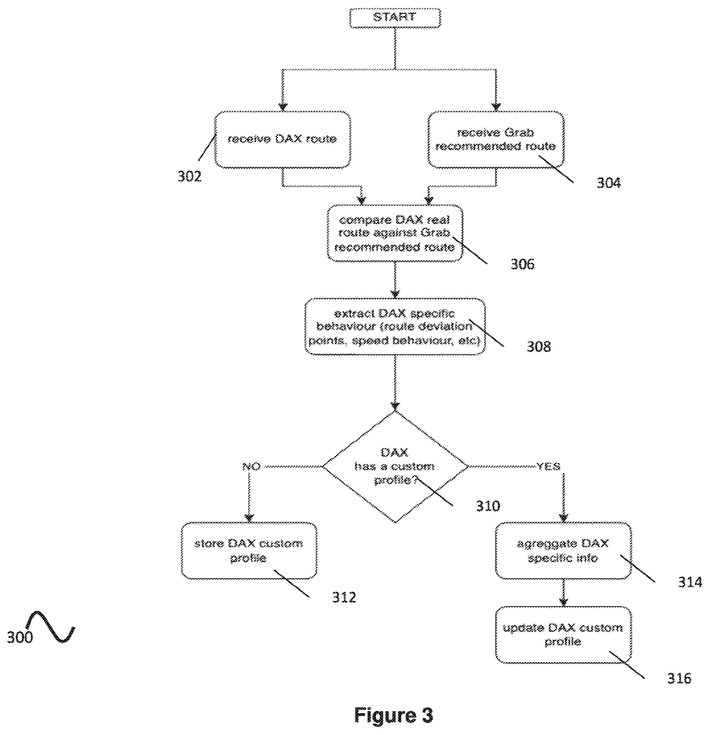

FIG. 3 is a flow chart diagram of a method for adaptively providing an estimated time of arrival for a ride by the graph generating server in the system of FIG. 1. According to various embodiments, the present disclosure advantageously separates a mapping layer (or a recommended route) for actual legal traffic restrictions like road (e.g. turn-restrictions/one-ways road segment attributes). Additionally or alternatively, the present disclosure presents a layer that provides a driving behavior of a driver, e.g. how likely the driver is to respect a certain turn restriction/one way sign. In various embodiments, the present disclosure could be also dependent on vehicle type of the driver. For example, it is more likely for a bicycle to go against one-way road on the side walk, while a car is more likely not to.

In various embodiments, the present disclosure may be used to separate legal or recommended routes and “popular” (i.e. most likely to be driven route). Advantageously, the present disclosure provides a personalization layer (or a personalised map) that learns about individual drivers (DAX) and how likely they are to follow the legal routes or not. Additionally or alternatively, the present disclosure provides a safety layer or a personalised map that monitors the behaviours from the drivers and partners by comparing our legal restriction layer in the map with drivers' real behaviours on the ground. This layer provides a comprehensive view and representative score for drivers' compliance regarding traffic rules.

In order to avoid legal problem, the present disclosure might not show the actual routes real people drive on the map using turn-by-turn instructions but we could use it to calculate our ETAs or possibly display it as a shortcut (with a warning that DAX should follow actual traffic rules).

One of the advantages is that this present disclosure provides real hyperlocal routes and ETAs, factoring in the recommended route so as to provide a personalized route for the driver.

FIG. 3 is a flow chart diagram of a method for adaptively providing an estimated time of arrival for a ride by the graph generating server in the system of FIG. 1. The method 300 may start when a request for a ride is received. The request may include location information identifying a destination of the ride. The ride may be one for a hail ride, a taxi ride or for a delivery/pick up for an item.

At step 304, a recommended route may be retrieved based on the location information. In an embodiment, the recommended route is one that is obtained based on the legal road segment attributes like a one-way sign. At step 302, a route specific to the driver (or DAX) may be received from a database. The route specific to the driver may be historical ride information relating to the driver. This may be done based on the location information included in the request and the route specific to the driver may be based on the rides that have been taken to the destination or rides that involve passing by the destination. It may be appreciated that the historical ride information may be used to identify a driving behaviour of the drivers who have taken similar or the same route before. It is to be appreciated in an embodiment, there is a profile for the driver who is on the ride. In this embodiment, the historical information may include rides that have been taken by the driver to the same destination. Additionally, or alternatively, an aggregated profile may be used. That is, the historical information may include information of other rides taken by other drivers to the same destination (e.g., “Riders in Jakarta usually take this route”). Advantageously, this present disclosure is configured to adaptively provide an estimated time of arrival for a new driver who does not have a profile or for the first time. The present disclosure will get more accurate over time in predicting an estimated time of arrival for the driver.

At step 306, the method includes comparing the routes received in steps 302 and 304. At step 308 the method includes extracting DAX specific behaviour. This includes drivers who have taken similar route before. Based on the received recommended route, the method includes identifying a road segment attribute that may be present during the ride. Based on the DAX route, it is determined whether or not the driver is likely to respect the road segment attribute that may be found during the ride. For example, based on the historical ride information as shown in the DAX route, it is determined if it is likely for the driver to follow a one-way turn or other similar road segment attributes. It is to be appreciated that the driving behaviour of the driver or DAX specific behaviour is extracted. In an embodiment, it is determined if the driver is likely to take route deviation (e.g., by bypassing a road segment attribute or taking a shortcut). Additionally or alternatively, it is determined if the driver has traffic points deducted while taking the same route in the past. In an embodiment, if it is determined that the driver is not likely to follow the road segment attribute, the method comprises generating a warning message to be displayed.

At step 310, it is determined if the driver has a custom profile. At step 314, when it is determined that the driver has a custom profile, the method includes aggregating the driver information. This may include aggregating a score for the driver on how likely he is to take a route deviation. Advantageously, the present disclosure is able to adaptively provide an estimated time of arrival for a ride by providing a personalized map for a driver for the ride more accurately. At step 316, the custom profile may be updated with the aggregated information.

At step 312, when it is determined that the driver does not have a custom profile, the method includes creating a custom profile for the driver. As such, relevant information relating to the driver may be saved.

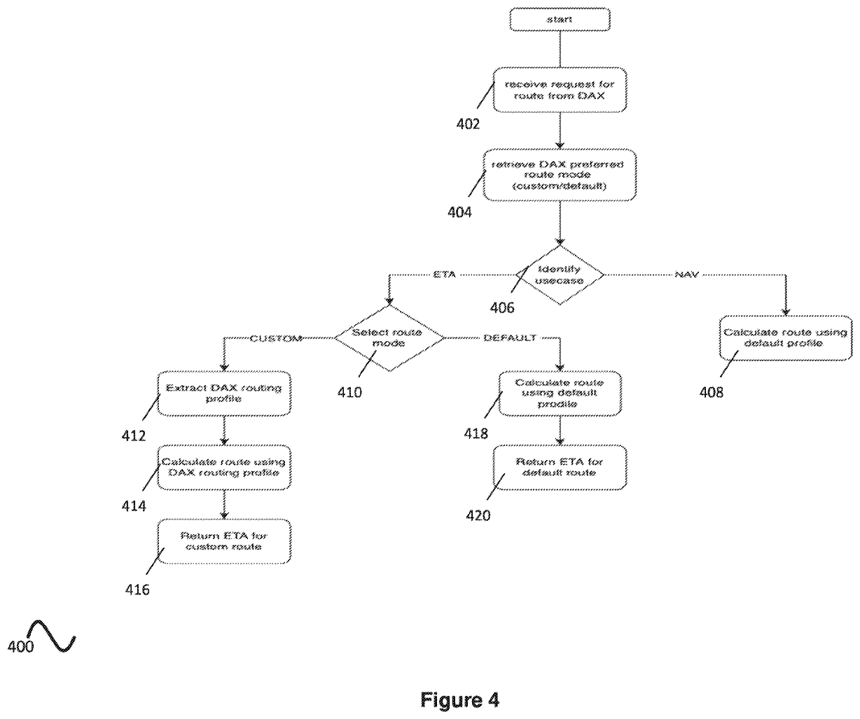

FIG. 4 is a flow chart diagram of a method for adaptively providing an estimated time of arrival for a ride by the graph generating server in the system of FIG. 1.

At step 402, a request for a route may be received from a driver (or DAX). At step 404, a route that is preferred by the driver may be retrieved. This route may be a custom or a default one.

At step 406, the method includes identifying whether or not there is a user profile that has been created for the driver. In the event that it is determined that it is navigation mode (or “NAV”), a route or personalized route is calculated or determined using a default profile. In an embodiment, the method enters the navigation mode when it determines that there is no user profile that has been created for the driver. In this embodiment, information relating to other drivers who haven taken similar or the same route may be used.

At step 410, the method includes determining a route mode. In the event that it is determined that it should be a default mode, a route is calculated using the default profile in step 418. At step 420, an ETA is generated and provided for the default route determined in step 418.

At step 412, a drive routing profile is extracted. In the event that it is determined that it should be a custom mode, a driver route is extracted in step 412. At step 414, a route is calculated using a driver (or DAX) routing profile. At step 416, an ETA for the custom mode is generated and provided.

The present disclosure may include identifying a road segment attribute in the retrieved recommended route, the road segment attribute comprises at least one of a turn restriction. Additionally or alternatively, the present disclosure may include determining if the driver is likely to follow the road segment attribute, and generating a warning message when it is determined that the driver is not likely to follow the road segment attribute.

Additionally or alternatively, the present disclosure may include determining a type of vehicle that is used by the driver for the ride, wherein the step of determining if the driver is likely to follow the road segment attribute depends on the type of the vehicle.

Additionally or alternatively, the present disclosure may include retrieving a recommended route for the ride, wherein the step of providing the personalized map includes comparing the recommended route and the historical ride information.

Additionally or alternatively, the present disclosure may include determining if the driver has a profile; aggregating information when it is determined that the driver does not have a profile; and updating the profile based on the aggregated information.

Additionally or alternatively, the present disclosure may include receiving a request for the ride, the request including location information identifying a destination of the ride, wherein the step of identifying historical ride information relating to the driver is done based on the identified destination.

Advantageously, the present disclosure provides a higher accuracy in ETAs by providing methods and systems to separate route deviations that are usual shortcuts from route deviations that are unusual for the current trip. This could create a truly hyperlocal mapping layer or a personalised map for the driver.

### Structural Context of the Graph Generating Server 108

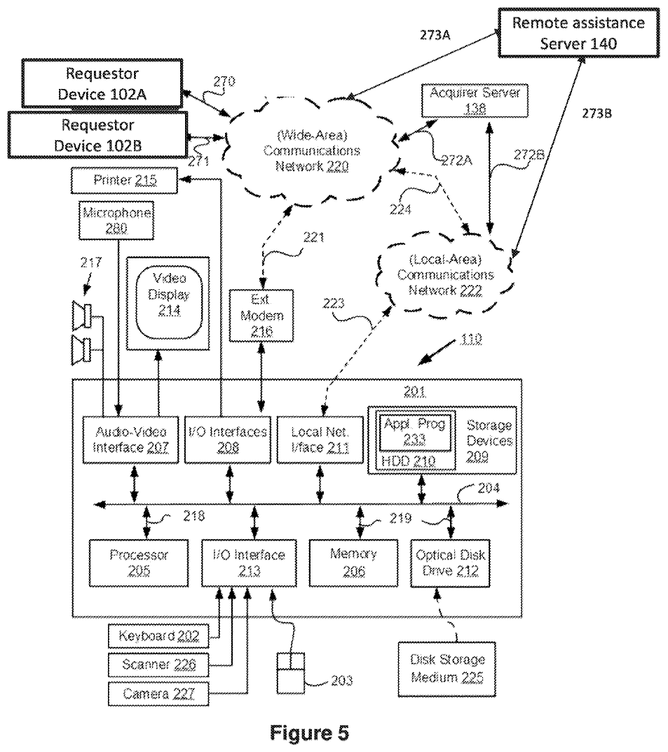

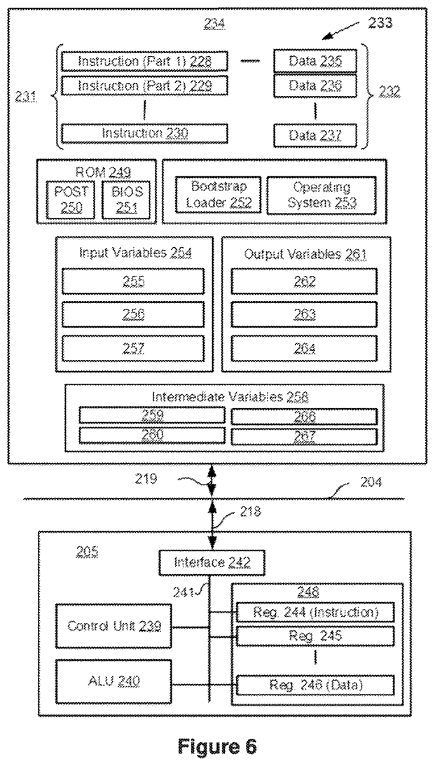

FIGS. 5 and 6 depict the graph generating server 108, upon which the system described above can be practiced.

As seen in FIG. 5, the graph generating server 108 includes: a computer module 201; input devices such as a keyboard 202, a mouse pointer device 203, a scanner 226, a camera 227, and a microphone 280; and output devices including a printer 215, a display device 214 and loudspeakers 217. An external Modulator-Demodulator (Modem) transceiver device 216 may be used by the computer module 201 for communicating to and from a communications network 220 via a connection 221. The communications network 220 may be a wide-area network (WAN), such as the Internet, a cellular telecommunications network, or a private WAN. Where the connection 221 is a telephone line, the modem 216 may be a traditional “dial-up” modem. Alternatively, where the connection 221 is a high capacity (e.g., cable) connection, the modem 216 may be a broadband modem. A wireless modem may also be used for wireless connection to the communications network 220.

The input and output devices may be used by an operator who is interacting with the graph generating server 108. For example, the printer 215 may be used to print reports relating to the status of the graph generating server 108.

The graph generating server 108 uses the communications network 220 to communicate with the requestor devices 102 to receive commands and data. The graph generating server 108 also uses the communications network 220 to communicate with the requestor devices 102 to send notification messages or broadcast transaction records.

The computer module 201 typically includes at least one processor unit 205, and at least one memory unit 206. For example, the memory unit 206 may have semiconductor random access memory (RAM) and semiconductor read only memory (ROM). The computer module 201 also includes a number of input/output (I/O) interfaces including: an audio-video interface 207 that couples to the video display 214, loudspeakers 217 and microphone 280; an I/O interface 213 that couples to the keyboard 202, mouse 203, scanner 226, camera 227 and optionally a joystick or other human interface device (not illustrated); and an interface 208 for the external modem 216 and printer 215. In some implementations, the modem 216 may be incorporated within the computer module 201, for example within the interface 208. The computer module 201 also has a local network interface 211, which permits coupling of the computer system 110 via a connection 223 to a local-area communications network 222, known as a Local Area Network (LAN).

As illustrated in FIG. 5, the local communications network 222 may also couple to the wide network 220 via a connection 224, which would typically include a so-called “firewall” device or device of similar functionality. The local network interface 211 may comprise an Ethernet circuit card, a Bluetooth® wireless arrangement or an IEEE 802.11 wireless arrangement; however, numerous other types of interfaces may be practiced for the interface 211.

The I/O interfaces 208 and 213 may afford either or both of serial and parallel connectivity, the former typically being implemented according to the Universal Serial Bus (USB) standards and having corresponding USB connectors (not illustrated). Storage devices 209 are provided and typically include a hard disk drive (HDD) 210. Other storage devices such as a floppy disk drive and a magnetic tape drive (not illustrated) may also be used. An optical disk drive 212 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the graph generating server 108.

The components 205 to 213 of the computer module 201 typically communicate via an interconnected bus 204 and in a manner that results in a conventional mode of operation of a computer system known to those in the relevant art. For example, the processor 205 is coupled to the system bus 204 using a connection 218. Likewise, the memory 206 and optical disk drive 212 are coupled to the system bus 204 by connections 219. Examples of computers on which the described arrangements can be practised include IBM-PC's and compatibles, Sun Sparcstations, Apple Mac™ or like computer systems.

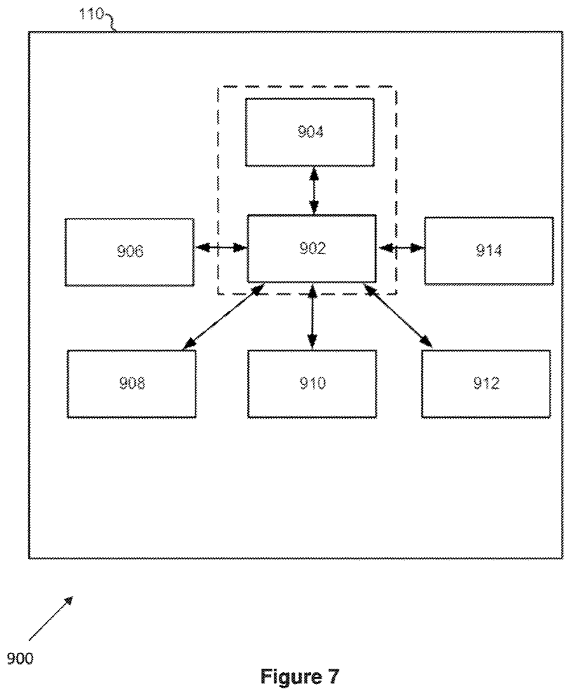

The methods of operating the server 108, as shown in the processes of FIGS. 2, 3, and 4 to be described, may be implemented as one or more software application programs 233 executable within the graph generating server 108. In particular, the steps of the methods shown in FIGS. 2, 3, and 4 to be described, may be implemented as one or more software application program are effected by instructions 231 (see FIG. 7) in the software (e.g., computer program codes) 233 that are carried out within the transaction processing server 110. The software instructions 231 may be formed as one or more code modules, each for performing one or more particular tasks. The software may also be divided into two separate parts, in which a first part and the corresponding code modules performs the operation of the graph generating server 108 and a second part and the corresponding code modules manages the API and corresponding user interfaces in the requestor devices 102, and on the display 214. In other words, the second part of the software manages the interaction between (a) the first part and (b) any one of the requestor devices 102, and the operator of the server 108.

The software may be stored in a computer readable medium, including the storage devices described below, for example. The software is loaded into the graph generating server 108 from the computer readable medium, and then executed by graph generating server 108. A computer readable medium having such software or computer program recorded on the computer readable medium is a computer program product.

The software (e.g., computer program codes) 233 is typically stored in the HDD 210 or the memory 206. The software 233 is loaded into server 108 from a computer readable medium (e.g., the memory 206), and executed by the processor 205. Thus, for example, the software 233 may be stored on an optically readable disk storage medium (e.g., CD-ROM) 225 that is read by the optical disk drive 212. A computer readable medium having such software or computer program recorded on it is a computer program product. The use of the computer program product in the server 108 preferably effects an apparatus for processing transaction requests for functioning as a transaction management system.

In some instances, the application programs 233 may be supplied to the user encoded on one or more CD-ROMs 225 and read via the corresponding drive 212, or alternatively may be read by the user from the networks 220 or 222. Still further, the software can also be loaded into the transaction processing server 110 from other computer readable media. Computer readable storage media refers to any non-transitory tangible storage medium that provides recorded instructions and/or data to the graph generating server 108 for execution and/or processing by the processor 205. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 201. Examples of transitory or non-tangible computer readable transmission media that may also participate in the provision of software, application programs, instructions and/or data to the computer module 201 include radio or infra-red transmission channels as well as a network connection to another computer or networked device, and the Internet or Intranets including e-mail transmissions and information recorded on Websites and the like.

The second part of the application programs 233 and the corresponding code modules mentioned above may be executed to implement one or more API of the server 108 with associated graphical user interfaces (GUIs) to be rendered or otherwise represented upon the display 214 or the display of the requestor device 102. Through manipulation of typically the keyboard 202 and the mouse 203, an operator of the server 110 and the application may manipulate the interface in a functionally adaptable manner to provide controlling commands and/or input to the applications associated with the GUI(s). Similarly, on requestor devices 101, a user of those devices 102 manipulate the input devices (e.g., touch screen, keyboard, mouse, etc.) of those devices 102 in a functionally adaptable manner to provide controlling commands and/or input to the applications associated with the GUI(s). Other forms of functionally adaptable user interfaces may also be implemented, such as an audio interface utilizing speech prompts output via the loudspeakers 217 and user voice commands input via the microphone 280. These other forms of functionally adaptable user interfaces may also be implemented on the devices 102.

FIG. 6 is a detailed schematic block diagram of the processor 205 and a “memory” 234. The memory 234 represents a logical aggregation of all the memory modules (including the HDD 209 and semiconductor memory 206) that can be accessed by the computer module 201 in FIG. 6.

When the computer module 201 is initially powered up, a power-on self-test (POST) program 250 executes. The POST program 250 is typically stored in a ROM 249 of the semiconductor memory 206 of FIG. 7. A hardware device such as the ROM 249 storing software is sometimes referred to as firmware. The POST program 250 examines hardware within the computer module 201 to ensure proper functioning and typically checks the processor 205, the memory 234 (209, 206), and a basic input-output systems software (BIOS) module 251, also typically stored in the ROM 249, for correct operation. Once the POST program 250 has run successfully, the BIOS 251 activates the hard disk drive 210 of FIG. 7. Activation of the hard disk drive 210 causes a bootstrap loader program 252 that is resident on the hard disk drive 210 to execute via the processor 205. This loads an operating system 253 into the RAM memory 206, upon which the operating system 253 commences operation. The operating system 253 is a system level application, executable by the processor 205, to fulfil various high level functions, including processor management, memory management, device management, storage management, software application interface, and generic user interface.

The operating system 253 manages the memory 234 (209, 206) to ensure that each process or application running on the computer module 201 has sufficient memory in which to execute without colliding with memory allocated to another process. Furthermore, the different types of memory available in the server 108 of FIG. 7 must be used properly so that each process can run effectively. Accordingly, the aggregated memory 234 is not intended to illustrate how particular segments of memory are allocated (unless otherwise stated), but rather to provide a general view of the memory accessible by the server 108 and how such is used.

As shown in FIG. 6, the processor 205 includes a number of functional modules including a control unit 239, an arithmetic logic unit (ALU) 240, and a local or internal memory 248, sometimes called a cache memory. The cache memory 248 typically includes a number of storage registers 244-246 in a register section. One or more internal busses 241 functionally interconnect these functional modules. The processor 205 typically also has one or more interfaces 242 for communicating with external devices via the system bus 204, using a connection 218. The memory 234 is coupled to the bus 204 using a connection 219.

The application program 233 includes a sequence of instructions 231 that may include conditional branch and loop instructions. The program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, the processor 205 is given a set of instructions which are executed therein. The processor 205 waits for a subsequent input, to which the processor 205 reacts to by executing another set of instructions. Each input may be provided from one or more of a number of sources, including data generated by one or more of the input devices 202, 203, data received from an external source across one of the networks 220, 202, data retrieved from one of the storage devices 206, 209 or data retrieved from a storage medium 225 inserted into the corresponding reader 212, all depicted in FIG. 6. The execution of a set of the instructions may in some cases result in output of data. Execution may also involve storing data or variables to the memory 234.

The disclosed transaction management arrangements use input variables 254, which are stored in the memory 234 in corresponding memory locations 255, 256, 257. The transaction management arrangements produce output variables 261, which are stored in the memory 234 in corresponding memory locations 262, 263, 264. Intermediate variables 258 may be stored in memory locations 259, 260, 266 and 267.

Referring to the processor 205 of FIG. 6, the registers 244, 245, 246, the arithmetic logic unit (ALU) 240, and the control unit 239 work together to perform sequences of micro-operations needed to perform “fetch, decode, and execute” cycles for every instruction in the instruction set making up the program 233. Each fetch, decode, and execute cycle comprises:

a fetch operation, which fetches or reads an instruction 231 from a memory location 228, 229, 230;

a decode operation in which the control unit 239 determines which instruction has been fetched; and

an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

Each step or sub-process in the processes of FIGS. 2, 3 and 4 is associated with one or more segments of the program 233 and is performed by the register section 244, 245, 247, the ALU 240, and the control unit 239 in the processor 205 working together to perform the fetch, decode, and execute cycles for every instruction in the instruction set for the noted segments of the program 233.

It is to be understood that the structural context of the graph generating server 108 is presented merely by way of example. Therefore, in some arrangements, one or more features of the graph generating server 108 may be omitted. Also, in some arrangements, one or more features of the graph generating server 108 may be combined together. Additionally, in some arrangements, one or more features of the graph generating server 108 may be split into one or more component parts.

FIG. 7 shows an alternative implementation of the graph generating server 108. In the alternative implementation, the graph generating server 108 may be generally described as a physical device comprising at least one processor 902 and at least one memory 904 including computer program code. The at least one memory 904 and the computer program code are configured to, with the at least one processor 902, cause the graph generating server 108 to perform the operations described in FIGS. 2, 3, 4, and 6. The graph generating server 108 may also include a transaction processing module 906, payment monitoring module 908, a registered user module 910, a registered merchant module 912, and credit risk limit module 914. The memory 904 stores computer program code that the processor 902 compiles to have each of the transaction processing module 906, the payment monitoring module 908, the registered user detail module 910, the registered merchant detail module 912, and the credit risk limit module 912 performs their respective functions. It will be appreciated that the processor 902 may also be configured to perform the functions performed by each of the transaction processing module 906, the payment monitoring module 908, the registered user detail module 910, the registered merchant detail module 912, and the credit risk limit module 912. In this arrangement, the transaction processing server 110 may only have a single processor 902 for performing the above-mentioned functions.

With reference to the discussion above regarding the devices 102, the registered user module 910 manages the on-boarding (see the on-boarding discussion above) and storing of users who are consumers who wish to buy products from registered merchants. With reference to the discussion above regarding the devices 102.

The arrangements described are applicable to the computer and data processing industries and particularly for the payment technology.

The foregoing describes only some embodiments of the present invention, and modifications and/or changes can be made thereto without departing from the scope and spirit of the invention, the embodiments being illustrative and not restrictive.

1. A computer-implemented method of adaptively providing an estimated time of arrival for a ride by providing a personalized map for a driver for the ride, the method comprising:
retrieving a recommended route for the ride;
identifying historical ride information relating to the ride, the historical ride information identifying driving behaviour of drivers who have taken the rides before; and
providing a personalized map for the driver based on the retrieved recommended route and the identified historical ride information so as adaptively provide an estimate time of arrival for a ride.

2. The method according to claim 1, further comprising identifying a road segment attribute in the retrieved recommended route, the road segment attribute comprises at least one of a turn restriction.

3. The method according to preceding claim 1, further comprising determining if the driver is likely to follow the road segment attribute based on the historical information, and generating a warning message when it is determined that the driver is not likely to follow the road segment attribute.

4. The method according to claim 1, further comprising determining a type of vehicle that is used by the driver for the ride, wherein the step of determining if the driver is likely to follow the road segment attribute depends on the type of the vehicle.

5. The method according to claim 1, further comprising retrieving a recommended route for the ride, wherein the step of providing the personalized map includes comparing the recommended route and the historical ride information.

6. The method according to claim 1, further comprising further comprising:
determining if the driver has a profile:
aggregating information when it is determined that the driver does not have a profile; and
updating the profile based on the aggregated information.

7. The method according to claim 1, further comprising receiving a request for the ride, the request including location information identifying a destination of the ride, wherein the step of identifying historical ride information relating to the ride is done based on the identified destination.

8. A server for adaptively providing an estimated time of arrival for a ride by providing a personalized map for a driver for the ride, the server comprising: at least one processor; and at least one memory including computer program code; the at least one memory and the computer program code configured to, with the at least one processor, cause the server at least to:
retrieve a recommended route for the ride:
identify historical ride information relating to the driver, the historical ride information identifying a driving behaviour of the driver based on rides that have been taken; and
provide a personalized map for the driver based on the retrieved recommended route and the identified historical ride information so as adaptively provide an estimate time of arrival for a ride.

9. The server according to claim 8, wherein the at least one memory and the computer program code is further configured with the at least one processor to identify a road segment attribute in the retrieved recommended route, the road segment attribute comprises at least one of a turn restriction.

10. The server according to claim 8 wherein the at least one memory and the computer program code is further configured with the at least one processor to determine if the driver is likely to follow the road segment attribute based on the historical information, and generating a warning message when it is determined that the driver is not likely to follow the road segment attribute.

11. The server according to claim 8, wherein the at least one memory and the computer program code is further configured with the at least one processor to determine a type of vehicle that is used by the driver for the ride, wherein the step of
determining if the driver is likely to follow the road segment attribute depends on the type of the vehicle.

12. The server according to claim 8, wherein the at least one memory and the computer program code is further configured with the at least one processor to retrieve a recommended route for the ride, wherein the step of providing the personalized map includes comparing the recommended route and the historical ride information.

13. The server according to claim 8, wherein the at least one memory and the computer program code is further configured with the at least one processor to:
determine if the driver has a profile;
aggregate information when it is determined that the driver does not have a profile; and
update the profile based on the aggregated information.

14. The server according to claim 8, wherein the at least one memory and the computer program code is further configured with the at least one processor to receive a request for the ride, the request including location information identifying a destination of the ride, wherein the step of identifying historical ride information relating to the driver is done based on the identified destination.
